(19) United States
(12) Patent Application Publication
(10) Pub. No.: US 2004/0172253 A1
(43) Pub. Date: Sep. 2, 2004

(54) Capture and playback web automation tool

(75) Inventor: Deepa Singh, Sunnyvale, CA (US)

Correspondence Address: David B. Ritchie, Thelen Reid & Priest LLP, P.O. Box 640640, San Jose, CA, 95164-0640, US

(73) Assignee: Sun Microsystems, Inc., a Delaware Corporation

(21) Appl. No.: 10/377,862

(22) Filed: Feb. 28, 2003

(51) Int. Cl. G10L 21/00

(52) U.S. Cl. 704/270.1

(57) ABSTRACT

A method for automating web applications on a web server uses a script file. The script file is generated on a proxy server. Web requests from a web browser to a web server and web responses in response to the web requests are intercepted and recorded onto a script file maintained on the proxy server. Web requests are submitted to the web server based on the script file. The script file may also be formatted pursuant to a specified data structure.

### FIELD OF THE INVENTION

The present invention relates to internet tools. More particularly, the present invention relates to system and method for testing web applications.

### BACKGROUND OF THE INVENTION

As the complexity and need for dependability of applications running on web servers increase, more rigorous testing is needed on these web applications. One way of testing these web applications is through automation of end-to-end web applications. Currently if an engineer is given the task of automating a web application which he has not developed, there is no way that the logic of the web application can be broken down into individual requests without seeing the source code of the web applications.

In particular, these web applications involve many requests such as Get and Post. Current available tools split all transactions into individual requests and send them to the web server one by one. In most cases, the engineer responsible for automating the web application is not the one who wrote it, therefore the task of automating the web application can become time consuming, especially in light of the growing complexity of web applications.

Thus the task of identifying queries and composing them in HyperText Markup Language (HTTP) protocol can become too complex and the corresponding cost can outweigh any benefits of automating the applications. A need therefore exists for automating a web application so that the entire web application can be executed with minimum user interaction.

### BRIEF DESCRIPTION OF THE INVENTION

A method for automating web applications on a web server uses a script file. The script file is generated on a proxy server. Web requests from a web browser to a web server and web responses in response to the web requests are intercepted and recorded onto a script file maintained on the proxy server. Web requests are submitted to the web server based on the script file. The script file may also be formatted pursuant to a specified data structure.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram of a system for a tool used for automating end to end web applications in accordance with one embodiment of the present invention.

FIG. 2 is a block diagram of components of a tool used for automating end to end web applications in accordance with one embodiment of the present invention.

FIG. 3 is a flow diagram of a method for capturing and recording transactions between a browser and a web server in accordance with one embodiment of the present invention.

FIG. 4 is a flow diagram of a method for submitting requests from a script in accordance with one embodiment of the present invention.

FIG. 5 is static class diagram of a proxy server in accordance with one embodiment of the present invention.

FIG. 6 is a sequence diagram of a proxy server in accordance with one embodiment of the present invention.

FIG. 7 is static class diagram of a web runner in accordance with one embodiment of the present invention.

FIG. 8 is a sequence diagram of a web runner in accordance with one embodiment of the present invention.

### DETAILED DESCRIPTION

Embodiments of the present invention are described herein in the context of a capture and playback web automation tool. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

In accordance with a specific embodiment of the present invention, a web tool may be used to record and playback web requests to a web application. The web application may be deployed on a web server and a web browser accessing the web application may be set to use a proxy server provided with the tool. If there are no application errors, the proxy server may record all transaction into a file, for example, an extended markup language (XML) file. Another tool may read the XML document and compose HyperText Transport Protocol (HTTP) requests and sends them to the targeted web server. By employing a tool with the capability to record and playback web requests to the web application, a test automation engineer does not have to be aware of the logic of the web application. Since the tool sends web requests byte by byte, the web application could be written using, for example, any of the following technology: Common Gateway Interface (CGI) using Practical Extraction Report Language (PERL), C, Java, Microsoft Active Server Page (ASP), Hypertext Preprocessor (PHP), and the like. Furthermore, the session management is preserved by checking for any cookies, which are data created by a web server and stored on a user's computer.

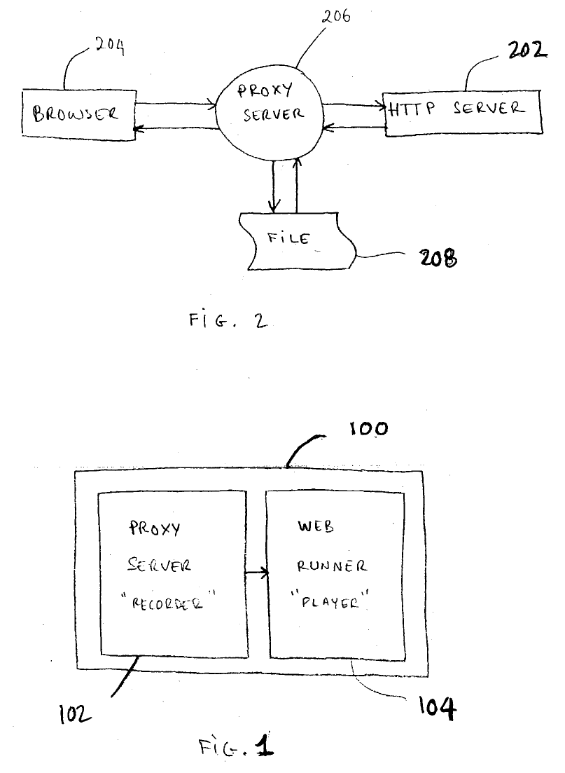

FIG. 1 is a block diagram illustrating components of a tool used for automating end-to-end web applications in accordance with one embodiment of the present invention. The tool 100 includes a proxy server 102 which captures and records web requests into a script or a file, and a web runner 104 which is software that plays out the scripts and simulates submitting web requests. Each part is described in more detail below.

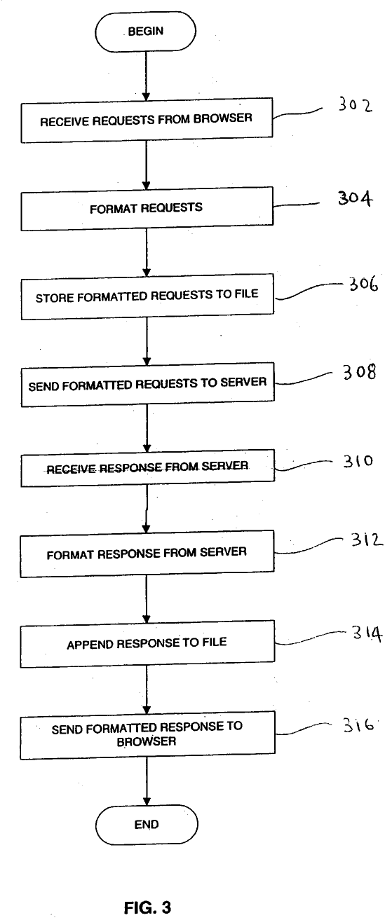

FIG. 2 is a block diagram of a system comprising a tool used for automating end-to-end web applications in accordance with one embodiment of the present invention. A web application to be tested resides on an HTTP server 202. A web browser 204 accesses the web application on HTTP server 202 through a proxy server 206. The proxy server 206 captures web requests submitted by the web browser 204 to the HTTP server 202. The captured web requests are recorded into one or more files 208. The recording aspect of the tool is described in more detail in FIG. 3.

FIG. 3 is a flow diagram illustrating a method for capturing and recording transactions between a web browser and a web server in accordance with one embodiment of the present invention. At 302, the proxy server 206 of FIG. 2 may capture a web request from browser 204. In accordance with one specific embodiment of the present invention, the web request may be in the form of a POST or GET instruction to the web application on the web server 202.

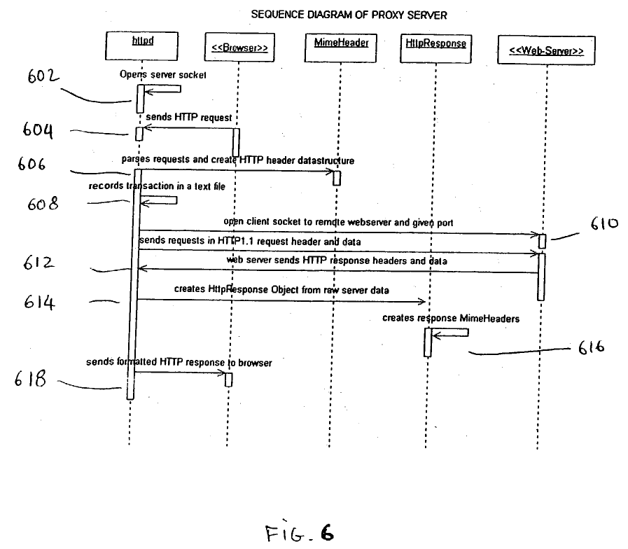

At 304, the web request may be formatted according to a provided specification or static class. An example of such a specification is listed in FIG. 5.

At 306, the formatted web request may be stored into a file 208. In accordance with one specific embodiment of the present invention, the file may include an Extensible Markup Language (XML) format.

At 308, the proxy server 206 may send the formatted web request to the web server 202.

After processing the formatted web requests, the HTTP server 202 may send a response to the proxy server 206 at 310. The web application may generate the response based on the submitted web requests.

The response from the HTTP server 206 may be formatted by proxy server 206 at 312 so that the web browser is able to read the response. The response may also be stored by appending it in the file 208 at 314.

After storing the response in the file 208, the proxy server may relay the response back to the web browser 204 at 316.

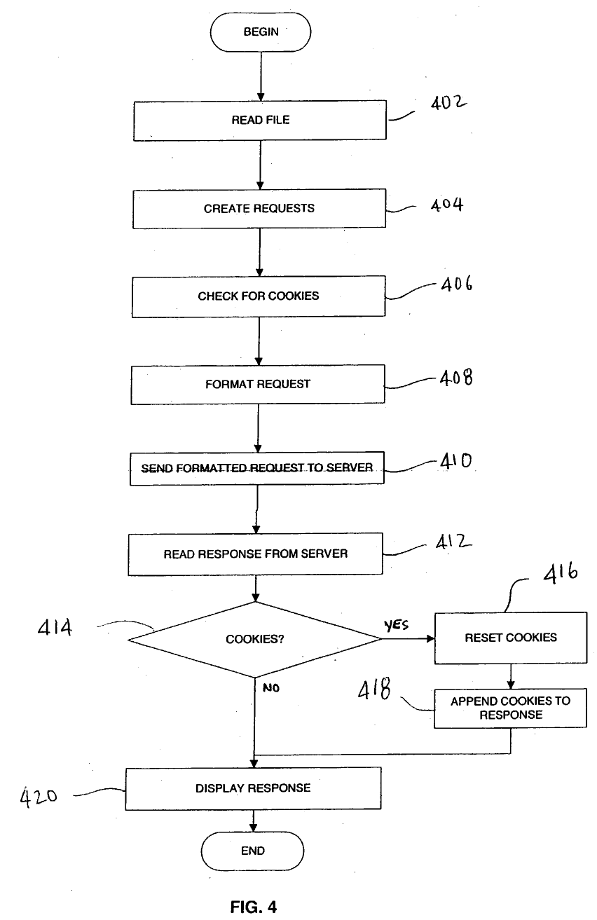

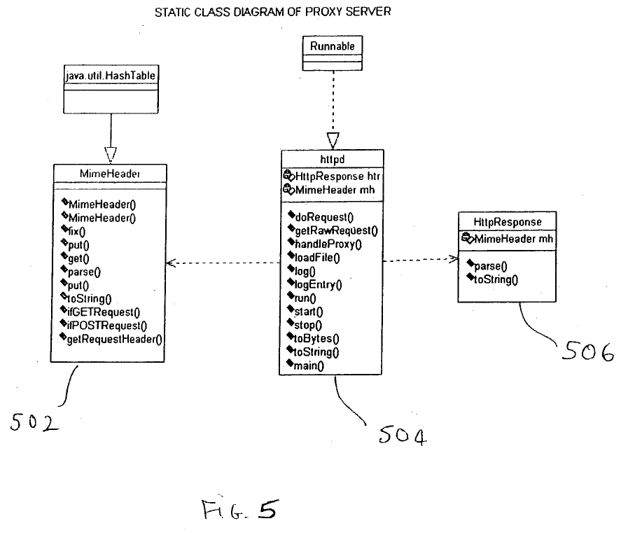

FIG. 4 is a flow diagram of a method for submitting web requests from a script in accordance with one embodiment of the present invention. Another aspect of the tool is used for submitting the stored web requests to the HTTP server. This may be accomplished by using an automated-client based server application verification tool, referred as a web runner. At 402, the web runner 104 of FIG. 1 may read the file 208 which contains the script for running web requests to the HTTP server 202. At 404, the web runner 104 creates a web request based on the content of the script file 208. The web runner 104 also checks for cookies stored along with the web requests in the file to preserve session management.

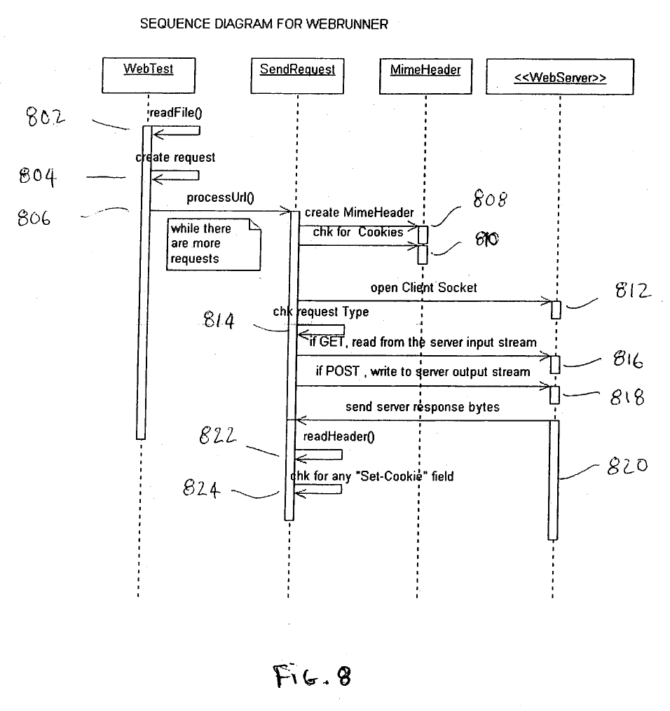

At 408, the web request extracted from the script file 208 may be formatted according to a provided specification, such as illustrated in FIG. 7. The formatted web request may then be sent to the web application residing on HTTP server 202 at 410. The web runner then receives a web response back from the web application at 412.

At 414, the web runner 104 may inspect the response for cookies. In particular, if cookies are found in the response, the web runner 104 clears the former cookies associated with the response stored in the file at 416. The web runner 104 then appends the new cookies to the response stored in the file at 418.

Finally, at 420, the response may be displayed on the web browser 204.

FIG. 5 is a static class diagram of a proxy server in accordance with one embodiment of the present invention. Web requests received by the proxy server include functions listed under the MimeHeader table 502. The web requests may then be formatted using the class diagram in HTTP table 504. Responses from the web application may be formatted under the HTTP Response table 506. One of ordinary skill in the art will recognize that the static classes described in FIG. 5 are for illustration purposes and that the static classes of a proxy server in accordance with one specific embodiment of the present invention are not limited to those described in FIG. 5.

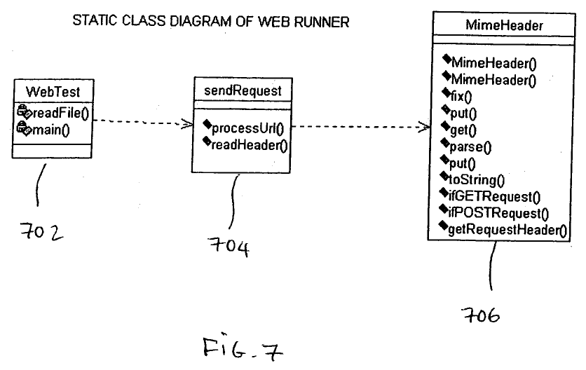

FIG. 6 is a sequence diagram of a proxy server in accordance with one embodiment of the present invention. At 602, the proxy server may open a server socket that is provided. At 604, the web browser may send an HTTP request to the proxy server. At 606, the proxy server parses the web requests and creates an HTTP header data structure as illustrated in FIG. 5. At 608, the proxy server may record the transaction in a text file. In accordance with another embodiment, the proxy server may store the transaction of a web request in a memory location as well as on a disk file. At 610, the proxy server may open the client socket to access the remote web server on the given port. The proxy server may also send requests in, for example, using HTTP 1.1 request header and data. At 612, the web server may send HTTP response headers and data back to the proxy server. At 614, the proxy server may create an HTTP Response Object from the raw server data. At 616, the HTTP Response Object may create corresponding MimeHeaders. At 618, the proxy server may send the formatted HTTP response to the browser.

FIG. 7 is a static class diagram of a web runner in accordance with one embodiment of the present invention. The web runner may read from the file using WebTest class 702 and send the requests using the sendRequest class 704. The web requests submitted by the web runner may also include a MimeHeader class 706. One of ordinary skill in the art will recognize that the static classes described in FIG. 7 is for illustration purposes and that the static classes of a web runner in accordance with one specific embodiment of the present invention are not limited to those described in FIG. 7.

FIG. 8 is a sequence diagram of a web runner in accordance with one embodiment of the present invention. At 802, the web runner may read from the file containing the recorded web requests. At 804, the web runner may create web requests based on the content of the file. At 806, the web runner processes one web request at a time to the server. One way to accomplish this is by creating a MimeHeader at 808 and also to check for cookies at 810.

Once the web runner processes and submits the web request to the Web Server, a Client Socket may be opened to access the Web Server at 812.

At 814, the Web runner also checks for request types. That is, if the request is in the form of “GET”, the web runner reads from the server input stream at 816. If the request is in the form of “POST”, the web runner writes to the server output stream at 818.

After processing the submitted web request, the web server may send response bytes at 820. At 822, the Web Runner may read from the Header field of the response and check for any “Set-Cookie” field at 824.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for recording web transactions comprising:
receiving a web request from a web browser;
formatting said web request;
storing said web request in a script file; and
sending said formatted web request to a web server.

2. The method of claim 1 further comprising:
receiving a web response in response to said formatted web request from said web server;
formatting said web response;
appending said response to said script file; and
sending said formatted response to said web browser.

3. The method of claim 1 wherein formatting said web request further comprises:
parsing said web request; and
creating an HTTP header data structure for said parsed web request.

4. The method of claim 2 wherein said formatting said web response further comprises:
creating an HTTP Response Object from said web response; and
creating a MimeHeader for said HTTP Response Object.

5. A method for automating web transactions comprising:
reading a script file, said script file having at least one web requests;
creating a web request based on said script file;
formatting said web request; and
sending said formatted web request to a web server.

6. The method according to claim 5 further comprising:
receiving a web response in response to said formatted web request to said web server;
checking said web response for cookies; and
displaying said web response.

7. The method according to claim 6 wherein said checking further comprises:
resetting said cookies in said web response.

8. The method according to claim 5 wherein said formatting further comprises:
creating an HTTP header data structure for said web request.

9. A method for automating web applications comprising:
generating a script file on a proxy server, said script file storing web requests from a web browser to a web server and web responses from said web server back to said web browser; and
submitting web requests based on said script file to said web server.

10. The method of claim 9 wherein said generating further comprises:
intercepting web requests from said web browser to said web server;
intercepting web responses from said web server to said web browser; and
storing said web requests and said web responses in said script file.

11. The method of claim 9 further comprising:
formatting said web requests pursuant to a first data structure; and
formatting said web responses pursuant to a second data structure.

12. The method of claim 11 wherein said first data structure includes an HTTP header data structure.

13. The method of claim 11 wherein said second data structure includes an HTTP mime header data structure.

14. An apparatus for automating web applications comprising:
a proxy server; and
a web runner coupled said proxy server.

15. The apparatus of claim 14 wherein said proxy server further comprises a script file, said script file including web requests from web browser to a web server, and web responses in response to said web requests.

16. The apparatus of claim 15 wherein said web runner further comprises said script file.

17. A program storage device readable by a machine, tangibly embodying a program of instructions readable by the machine to perform a method for recording web transactions, the method comprising:
receiving a web request from a web browser;
formatting said web request;
storing said web request in a script file; and
sending said formatted web request to a web server.

18. A program storage device readable by a machine, tangibly embodying a program of instructions readable by the machine to perform a method for automating web transactions, the method comprising:
reading a script file, said script file having at least one web requests;
creating a web request based on said script file;
formatting said web request; and
sending said formatted web request to a web server.

19. A program storage device readable by a machine, tangibly embodying a program of instructions readable by the machine to perform a method for automating web transactions, the method comprising:
generating a script file on a proxy server, said script file storing web requests from a web browser to a web server and web responses from said web server back to said web browser; and
submitting web requests based on said script file to said web server.

20. An apparatus for recording web transactions comprising:
means for receiving a web request from a web browser;
means for formatting said web request;
means for storing said web request in a script file; and
means for sending said formatted web request to a web server.

21. An apparatus for automating web transactions comprising:
means for reading a script file, said script file having at least one web requests;
means for creating a web request based on said script file;
means for formatting said web request; and
means for sending said formatted web request to a web server.

22. An apparatus for automating web applications comprising:
means for generating a script file on a proxy server, said script file storing web requests from a web browser to a web server and web responses from said web server back to said web browser; and
means for submitting web requests based on said script file to said web server.
